(19) United States
(12) Patent Application Publication
(10) Pub. No.: US 2016/0005017 A1
(43) Pub. Date: Jan. 7, 2016

(54) Kiosk and Currency Management System

(71) Applicant: INTEGRATED PAYMENT TECHNOLOGIES, LLC, Atlanta, GA (US)

(72) Inventor: Julius Cato, Sandy Springs, GA (US)

(21) Appl. No.: 14/770,119

(22) PCT Filed: Feb. 28, 2014
(86) PCT No.: PCT/US14/19506

§ 371 Date: Aug. 25, 2015

Related U.S. Application Data
(60) Provisional application No. 61/770,914, filed on Feb. 28, 2013.

(51) Int. Cl. G06Q 20/18; G06Q 20/10; G07D 11/00

(52) U.S. Cl. CPC G06Q 20/18; G07D 11/0021; G07D 11/0078; G06Q 20/10

(57) ABSTRACT

An embodiment of a kiosk and currency management system and method enable quick and accurate exchanges of relatively large denomination input currency for relatively small denomination output currency. For example, the systems and methods enable the exchange of input currency having a first value and first denomination for output currency having a second lower value and a second lower denomination. Such exchanges may be quick and accurate, which may be desirable for the customer and the proprietor of the establishment into which a kiosk and currency management system is placed.

### RELATED APPLICATION

This application claims priority to copending U.S. provisional application entitled, “Kiosk and Currency Management System,” having Ser. No. 61/770,914, filed Feb. 28, 2013, which is entirely incorporated herein by reference.

### TECHNICAL FIELD

The present disclosure is related to methods of business and, more particularly, is related to systems and methods of providing currency management.

### BACKGROUND

Participation at many entertainment venues requires the expenditure of money. At some of these venues, money is often expended in the form of small denomination cash currency, such as single ($1.00) bills. For example, small denomination currency may be required at establishments such as arcades, and preferred at establishments such as adult entertainment clubs. As another example, patrons may wish to tip a relative small amount to service personnel at a hotel, such as valets, coat check, bellman

In today's society, many individuals opt to use alternative payment methods in lieu of cash currency such as credit cards, debit cards, gift cards, electronic fund transfers, and checks. These individuals may not carry small denomination cash currency, or may carry such a small quantity of small denomination currency that their participation at certain entertainment venues is impeded.

Before patronizing an entertainment venue where small denomination currency is required, the individual may obtain currency from a bank or an automatic teller machine. The currency obtained is often large denomination currency in the form of $20, $50, or $100 dollar bills. Because these denominations may be too large to be useful at an entertainment venue, the individual may exchange the large denomination currency for small denomination currency before participating.

Exchanging large denomination currency for small denomination currency at the entertainment venue may be undesirable for both the individual and the entertainment venue. The entertainment venue may have a limited volume of small denomination currency on hand. Once this volume is depleted, the entertainment venue may be unable to complete the individuals exchange request, which may cause the individual to expend less money at the venue. Further, replenishing the volume of small denomination currency may be inconvenient for the entertainment venue. For example, replenishing the volume of currency may require visiting a bank, which may not be open. Additionally, exchanging large denomination currency for small denomination currency often requires manual counting by an employee of the entertainment venue. The time consumed exchanging currency by manual counting may inconvenience the participant and distract the employee from fulfilling her job responsibilities. Mistakes may also occur that are costly to the entertainment venue. Further, manual counting does not enable the detection of counterfeit bills.

From the above, it is apparent that a need exists for a system and method of providing and managing currency that eliminates these problems.

### BRIEF DESCRIPTION OF THE DRAWINGS

The present disclosure may be better understood with reference to the following drawings. Matching reference numerals designate corresponding parts throughout the Figures, and components in the drawings are not necessarily to scale.

FIG. 1A is a block diagram illustrating an embodiment of a kiosk and currency management system.

FIG. 1B is a block diagram illustrating an embodiment of the kiosk and currency management system of FIG. 1A, including kiosk and currency management software.

FIG. 2 is a block diagram illustrating an embodiment of a method for currency management.

FIG. 3 is a block diagram illustrating an embodiment of a general-purpose computer system that can be used to implement various systems and methods of currency management as disclosed herein.

FIG. 4 is a block diagram of an embodiment of a system for currency management.

### DETAILED DESCRIPTION

Described below are embodiments of a kiosk and currency management system, and of methods for providing and managing currency. The systems and methods disclosed herein may enable quick and accurate exchanges of relatively large denomination input currency for relatively small denomination output currency. For example, the systems and methods enable the exchange of input currency having a first value and first denomination for output currency having a second lower value and a second lower denomination. Such exchanges may be quick and accurate, which may be desirable for the customer and the proprietor of the establishment into which a kiosk and currency management system is placed.

The systems and methods disclosed herein thus allow the proprietor and staff to focus on servicing patrons rather than making change. Also, management can stay focused on operating of the establishment instead of going to a bank to get small denomination bills. Additionally, the proprietor's operating capital is kept safe and secure, since cash can be deposited daily into the kiosk and currency management system, and the system administrator can periodically deposit funds into a business checking account for the establishment.

Such exchanges may also generate revenue, which may be desirable for the proprietor and the administrator of a kiosk and currency management system. Under the methods herein, usage data generated by the system can be used by a proprietor to manage the system.

Other systems, devices, features, and advantages of the disclosed systems and methods for providing and managing currency will be or will become apparent to one of ordinary skill in the art upon examination of the following drawings and detailed description. All such additional systems, devices, features, and advantages are intended to be included within this description and are intended to be included within the scope of the present invention.

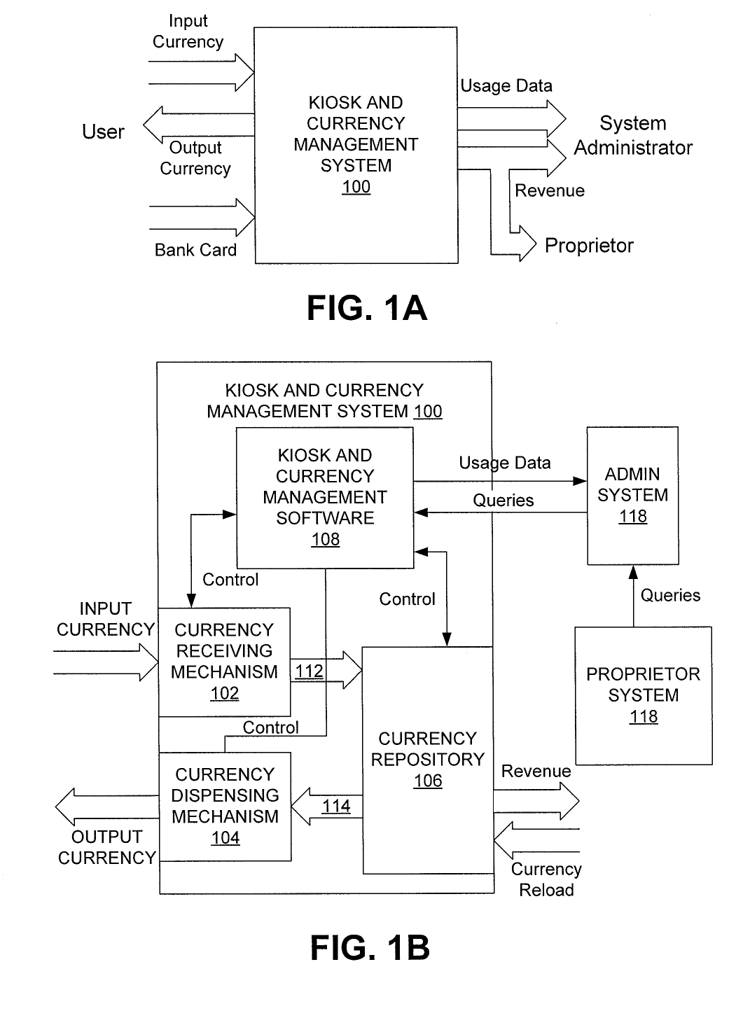

FIG. 1A is a block diagram of a kiosk and currency management system 100 showing the actors or entities involved, and various inputs of and outputs of the system 100. The system 100 is maintained by a system administrator and is placed in an establishment such as an entertainment venue that is owned by a proprietor. The proprietor allows users to use the system 100 for the purpose of exchanging input currency for output currency. Users may include customers of the establishment and workers at the establishment. Thus, in an adult entertainment venue, the actors interacting with the system 100 may include patrons and dancers in the user role, and a club manager in the proprietor role.

Bill conversion is one function supported by various embodiments of the kiosk and change management system, whereby large denomination bills may be exchanged for smaller denomination bills. These smaller denomination bills may then be used for tipping at an establishment. Examples include the conversion of $100, $50, $20 and $10 into $1 bills, also known as singles. Bill conversion may also involve the conversion from a foreign currency to U.S. bills. The operator of the kiosk and currency management system 100 may generate revenue from this bill conversion function by charging the user a fee for service. This fee may be implemented by discounting or holding back a portion of the currency provided to the user.

Some embodiments of the kiosk and currency management system 100 may also support transactions involving an automatic teller machine (ATM) card, a bank card, a credit card, a stored value card, or any other type of financial services card. Such embodiments may allow the user to withdraw funds from a financial account associated with the card and receive the funds in the form of small denomination bills such as singles. Conversely, the user may deposit currency, for example in the form of small denomination bills, into an account associated with the financial services card. These card services provided by the system 100 thus provide functionality analogous to an automated teller machine (ATM). The card services may also include foreign exchange when applicable, and in such cases the exchange rate may be subject to ATM processing regulations.

Some embodiments of the system 100 which include card services may support rollover between financial accounts. For example, if a patron or customer has exceeded his daily maximum withdrawal limit on a debit card he will be automatically be prompted to perform a point of service (POS) debit authorization in order to withdraw additional funds. The rollover functions may be linked or chained to multiple accounts. For example, if a patron has exceeded funds available from his debit card but has a credit card, he will be given information on accessing funds utilizing his credit cards via an access authorization process. The access authorization card may involve a personal identification (PIN) code, or may be PIN-less.

The operator of the kiosk and currency management system 100 may generate revenue from these functions by charging the user a fee for card services. Such fees may be assessed by surcharging the user's financial account and collected through the banking interchange or settlement process.

As noted earlier, workers in an establishment may also be users of the kiosk and change management system 100. Such workers are likely to have a need for services because the workers are receiving small-denomination bills from the patrons, sometimes in significant amounts. The currency exchange functions for workers may include accepting small-denomination bills, such as singles, through a bunch note validator, then loading the value of the input currency onto a prepaid credit card or stored value card. The system 100 may also dispense such prepaid or stored value cards. The operator of the kiosk and currency management system 100 may generate revenue from services provided to workers by charging the worker a fee for service. For example, the operator may charge the worker a fee to load the stored value card, or may collect transaction fees on such cards when the worker uses the card to make purchases.

Another function supported by some embodiments includes services for proprietors. One such service is the collection of fees from workers. For example, in an adult entertainment venue, it is typical for the proprietor to charge each dancer a “bar fee.” Some embodiments of the kiosk and currency management system 100 are operable to collect such fees from the worker, which allows the proprietor to avoid collecting fees from a dancer before she begins a work shift. The workers may pay bar fees by depositing cash into the system 100, or by using a financial services card such as a debit card, prepaid credit card, or stored value card. The amount of the bar fee may depend on factors such as time of day and day of the week. Various mechanisms may be used to identify the worker paying the fee, such as a PIN code, or a photo will be taken by the system 100 as the deposit is completed. The administrator of the kiosk and currency management system 100 may generate revenue from services provided to proprietors by charging the proprietor a per-transaction fee.

Another operation supported by some embodiments of the kiosk and currency management system 100 is fund transfer between the system 100 and a financial account associated with business establishment. This service allows a proprietor to cash into the system 100, and then the administrator electronically transfers corresponding funds to the proprietor's business checking account. This saves the proprietor time by avoiding a trip to the bank to deposit cash. The administrator may generate revenue from this service by charging the proprietor a transfer fee.

Revenue which may be generated as a result of these various uses of the system 100 may be returned to one or both of the system administrator and the proprietor.

As the system 100 operates, usage data 116 is generated, and the usage data 116 can be sent to the system administrator, who may use the data for a variety of uses. The uses of the data include maintaining the systems and determining usage trends, among others.

Reference is made to FIG. 1B, which is a block diagram illustrating an embodiment of a kiosk and currency management system 100. The system 100 includes a currency receiving mechanism 102, a currency dispensing mechanism 104, a currency repository 106, and kiosk and currency management software 108. The currency receiving mechanism 102 is configured to receive input currency 112 from a user 110 and to deliver the input currency 112 to the repository of currency 106. The kiosk and currency management software 108 is configured to determine output currency 114, which the currency dispensing mechanism 104 dispenses to the user 110. For example, the output currency can be U.S. currency in the form of bills having a denomination and value that is one of $1, $5, $10, $20, $50, and $100. The kiosk and currency management software 108 is configured to determine a value of the output currency 114, and a denomination of bills to be dispensed as output currency. The software 108 may control the operation of the currency receiving mechanism 102, currency dispensing mechanism 104, and currency repository 106, by sending various control signals and/or instructions, as should be appreciated.

In some embodiments, the denomination of each bill dispensed as output currency 114 is smaller than the denomination of the bill received as input currency 112, while the total value of the output currency 114 dispensed is less than or equal to the value of the input currency received. Alternative embodiments can include a payment receiving mechanism configured to receive payments through an electronic transfer including, but not limited to credit cards and debit cards, among others.

In the embodiment shown, the system 100 interacts with an administrator system 118 and a proprietor system 122. As the software 108 performs its various functions, usage data is generated and provided to the administrator system 118. The administrator system 118 may query the software 108 and/or run reports. The proprietor system 122 may also query the administrator system 188 and/or run reports.

The currency receiving mechanism 102 may include a bill validator. The repository of currency 106 can include, for example, a stacker or a lockable removable cassette for holding larger notes, a cassette for holding smaller notes, or both. The repository of currency 106 is intermittently refreshed by, for example, the system administrator or the proprietor. Refreshing the repository of currency 106 may include restocking the repository with relatively large quantities of currency in the denominations dispensed by the currency dispensing mechanism 104, and removing revenue 120 from the repository.

The kiosk and currency management software 108 is operable to determine the output currency 114 to be dispensed from the currency dispensing mechanism 104 based on the input currency 112 input into the currency receiving mechanism 102. More specifically, the kiosk and currency management software 108 is operable to determine a value of output currency 114 to be dispensed, and a denomination for bills to be dispensed as output currency. For example, an output currency 114 of ninety-four $1 bills has a value of $94 and a denomination of $1.

Based on the value of the input currency 112, the software 108 is operable to determine a value of the output currency 114. The software 108 may be operable to determine a value of the output currency 114 that is less than or equal to the value of the input currency 112. In some cases, the value of the output currency 114 determined by the logic 108 is less than the value of the input currency 112 regardless of the value of the input currency. In other cases, the value of the input currency 112 is used by the logic 108 to determine whether the value of the output currency 114 is the same as or lower than the value of the input currency 112. These embodiments are merely illustrative, and other embodiments of the software 108 may be operable to determine the value of the output currency 114 based on the value of the input currency 112 in a manner other than the manner described above.

Because the output currency 114 is dispensed in the form of a plurality of bills having specific denominations, the software 108 is also operable determine the denomination of bills to be dispensed as output currency 114, and for each denomination, the quantity of bills to be dispensed. In all cases, the denomination of each bill dispensed as output currency 114 is less than the denomination of the bill input as input currency 112. In some embodiments, the output currency 114 is dispensed in the form of a plurality of bills having a single denomination. In other embodiments, the output currency is dispensed using a combination of bills having varying denominations. For example, the output currency 114 may include one or more $10 bills and one or more $1 bills. In still other embodiments, the user 110 may choose the denomination of the output currency 114. In such an embodiment, the system 100 has an interface (not shown). The user 110 interacts with the interface to communicate his choice of denomination to the logic 108, which is configured to consider the choice in determining the denomination of the output currency 114. Once the logic 108 determines the value and denomination of output currency 114, bills having the value and denomination determined by the logic are dispensed from the repository of currency 106 through the currency dispensing mechanism 104 to the user 110.

The difference in value between the value of the input currency 112 provided by the user 110 and the value of output currency 114 returned to the user is revenue 120 of the kiosk and currency management system 100. The revenue 120 of the system 100 may be retained by the administrator 118 of the system 100, the proprietor 122 of the establishment, or some combination thereof. In one embodiment, the administrator 118 retains the revenue 120 until the revenue exceeds a threshold value, and shares the revenue with the proprietor 122 once the revenue exceeds the threshold. For example, the administrator 118 may retain the first $1000 in revenue 120, and may share the revenue with the proprietor 122 thereafter.

In a first embodiment, the system 100 is configured to receive bills of U.S. currency having a denomination of $50 or $100, and to dispense bills of U.S. currency having a denomination of $1 and/or $10. In such an embodiment, the currency receiving mechanism 102 accepts $50 bills and $100 bills, and rejects bills of any other denomination. For input currency 112 in the form of a $100 bill, the value of the output currency 114 determined by the logic 108 is $94 and the value of the revenue 120 retained by the system 100 is $6. The logic determines that seven bills having a $10 denomination and twenty-four bills having a $1 denomination will be dispensed as output currency 114. The currency dispensing mechanism 104 then dispenses seven $10 bills and twenty-four $1 bills from the repository of currency 106. For input currency 112 in the form of a $50 bill, the value of the output currency 114 determined by the software 108 is $45 and the value of the revenue 120 retained by the system 100 is $5. The software 108 determines that three bills having a $10 denomination and fifteen bills having a $1 denomination will be dispensed as output currency 114. The currency dispensing mechanism 104 then dispenses three $10 bills and fifteen $1 bills from the repository of currency 106.

In a second embodiment, the system 100 is configured to receive bills of U.S. currency having a denomination that is one of $5, $10, $20, $50, and $100, and to dispense bills of U.S. currency having a denomination of $1. In such an embodiment, the currency receiving mechanism 102 accepts $5 bills, $10 bills, $20 bills, $50 bills, or $100 bills, and rejects bills of any other denomination. In some embodiments, when input currency 112 is in the form of a $5 bill, the value of the output currency 114 determined by the software 108 is $5 and the value of the revenue 120 retained by the system 100 is $0. For input currency 112 in the form of a $10 bill, the value of the output currency 114 determined by the software 108 is $9 and the value of the revenue 120 retained by the system 100 is $1. For input currency 112 in the form of a $20 bill, the value of the output currency 114 determined by the software 108 is $18 and the value of the revenue 120 retained by the system 100 is $2. For input currency 112 in the form of a $50 bill, the value of the output currency 114 determined by the software 108 is $45 and the value of the revenue 120 retained by the system 100 is $5. For input currency 112 in the form of a $100 bill, the value of the output currency 114 determined by the software 108 is $94 and the value of the revenue 120 retained by the system 100 is $6.

In each case, the software 108 determines that bills having a $1 denomination should be dispensed as output currency 114. The software 108 then calculates the quantity of $1 bills to be dispensed, and the currency dispensing mechanism 104 dispenses the appropriate quantity from the repository of currency 106. Although for the embodiments discussed above, the value of output currency 114 is the same as the value of input currency 112 for a given transaction, in other embodiments, a transaction charge is assessed such that the value of output currency 114 is less than the value of input currency 112.

In a third embodiment, the system 100 is configured to receive bills of U.S. currency having a denomination of $5, $10, or $20, and to dispense bills of U.S. currency having a denomination of $1. In such an embodiment, the currency receiving mechanism 102 accepts $5 bills, $10 bills, and $20 bills, and rejects bills of any other denomination. For input currency 112 in the form of a $5 bill, the value of the output currency 114 determined by the software 108 is $5 and the value of the revenue 120 retained by the system 100 is $0. For input currency 112 in the form of a $10 bill, the value of the output currency 114 determined by the software 108 is $9 and the value of the revenue 120 retained by the system 100 is $1. For input currency 112 in the form of a $20 bill, the value of the output currency 114 determined by the software 108 is $18 and the value of the revenue 120 retained by the system 100 is $2. In each case, the software 108 determines that bills having a $1 denomination should be dispensed as output currency 114. The software 108 then calculates the quantity of $1 bills to be dispensed, and the currency dispensing mechanism 104 dispenses the appropriate quantity from the repository of currency 106.

In other embodiments, the system 100 may accept different denominations of bills than those described above, and for the denominations described, the system may dispense output currency 114 having a different value or in the form of different quantities and/or denominations of bills than described above. Such embodiments could be effectuated by altering the currency receiving mechanism 102 and/or the software 108. It will be understood that while specific scenarios for exchanging a particular amount of input currency 112 for another particular amount of output currency 114 are discussed herein, these are only examples, and other exchanges and fee structures are contemplated. Similarly, while specific mixes of input and output denominations are discussed herein, other mixes are possible.

It should be noted that the input currency 112 and output currency 114 is described above as being U.S. currency by way of example, and that in other embodiments, the input and/or output currency may be issued by a government other than the United States, or may be issued by an entity other than a government. For example, a particular establishment may choose to utilize a private currency that is only valid at that facility.

The software 108 is also operable to provide usage data 116 to the administrator 118. The usage data 116 can include any data that can be collected by the system. For example, the usage data 116 may include transaction data such as the time of an exchange, the denomination of input currency 112, the denomination of output 114 currency, the value of the output currency 114 dispensed, and the time and/or day of the transaction. The usage data 116 may also include other data such as the amount of currency available in the repository of currency 106, the frequency of use of the system 100, and the state of repair of the system 100. Such usage date 116 may be transmitted to the administrator 118 by the software 108. For example, the system 100 may include a wired or wireless communication device that is configured to transmit the usage data 116 to the administrator 118. The administrator 116 may use the usage data 116 to determine, for example, whether the repository of currency 106 needs to be replenished or whether the system 100 needs to be repaired. Additionally, the usage data may be used by the proprietor to determine periods of more or less profit.

The system 100 may be configured to perform the exchange relatively quickly. The user 110 may receive output currency 114 from the currency dispensing mechanism 114 within seconds of when the user input currency 112 into the currency receiving mechanism 102.

The various components of the system 100 may be housed within a console or kiosk. The console may be relatively secure and constructed of a physically resilient material. The console also can include a communication mechanism operable to communicate the usage data 116 from the system 100 to the administrator 118, using wired or wireless devices, or same combination thereof. An access door of the console may enable the administrator 118 or the proprietor 122 to access to an interior of the console for the purpose of removing currency from or adding currency to the repository of currency 106.

In embodiments not shown, the system 100 may include a counterfeit bill detector. The counterfeit bill detector may be a component of the currency receiving mechanism 102 or may be provided elsewhere within the system 100.

The administrator 118 may be, for example, an owner, lessor, or a provider of the system 100, and the proprietor 122 may be responsible for the establishment in which the system is placed. A variety of relationships may exist between the administrator 118 and the proprietor 122. For example, the administrator 118 may sell the system 100 to the proprietor 122, the administrator may retain ownership of the system, or the administrator may lease the system to the proprietor. A variety of financial arrangements may also exist between the administrator 118 and the proprietor 122. For example, the administrator 118 may charge the proprietor 122 a fee for the sale or lease of the system 100, the revenue of the system 100 may be given to the administrator 118 and/or proprietor, and the administrator may charge the proprietor a maintenance fee, such as a monthly fee. The maintenance fee may be in addition to or a substitute for a fee for selling or leasing the system 100, or for receiving the revenue of the system. The maintenance fee may entitle the proprietor 122 to services such as the use of the system 100, access to the usage data 116, and/or replenishment of the repository of currency 106. For example, the administrator 118 may maintain the currency stock within the repository of currency 106 by monitoring the usage data 116 to determine when the repository of currency 106 needs to be restocked, and by restocking the repository of currency 106 when needed. For example, the administrator may dispatch a secure transportation service, such as a Brinks truck, to restock the repository of currency 106. The currency within the repository of currency 106 may belong to the administrator 118 or to the proprietor 122. In cases in which the currency belongs to the administrator 118, the administrator 118 may assume the risk that a counterfeit bill may be present in the repository of currency 106. The administrator 118 and the proprietor 122 are described above as being separate and distinct from each other for illustrative purposes only. It should be noted that, in some embodiments, the administrator 118 and the proprietor 122 may be one and the same.

In embodiments not shown, the system 100 may also include a mechanism that is configured to embed a chemical on the output currency 114, the chemical being configured to cause currency to glow under certain lighting conditions. For example, the chemical may be embedded on the currency by coating, spraying, or dipping, among others. In some embodiments, the mechanism that embeds the chemical on the currency may be a component of the system 100. The mechanism may be housed within the console or outside of the console, in which case the output currency 114 may be embedded with the chemical before the currency is loaded into the console. In other embodiments, the mechanism can be used apart from the system 100 altogether, which may be desirable in cases in which it is desirable to have currency embedded with the chemical, but use of the system 100 is not desired. Use of currency embedded with the chemical may be desirable in dark entertainment venues.

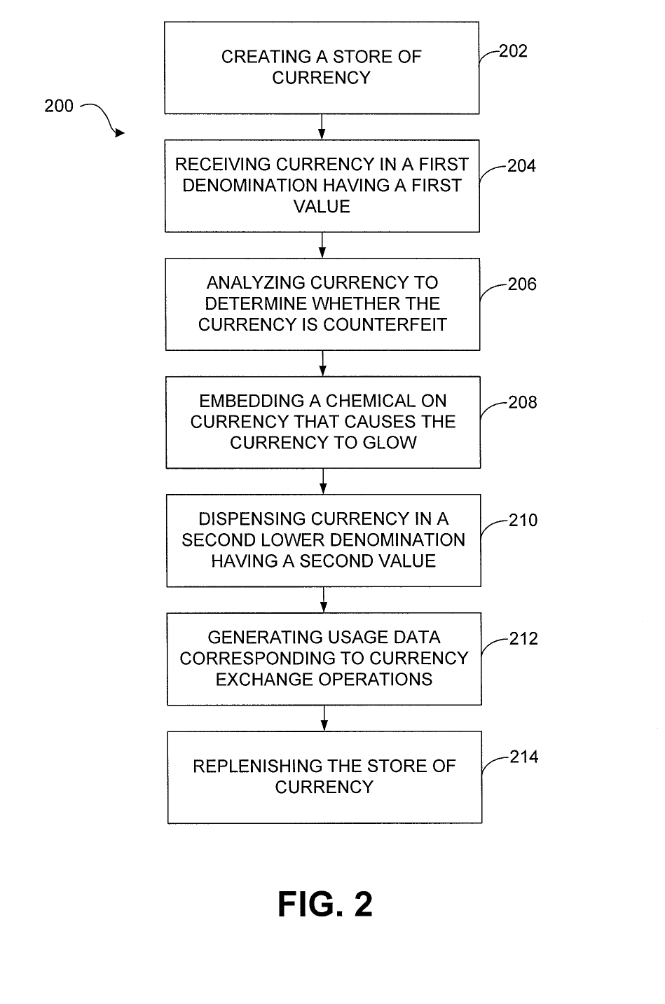

Reference is now made to FIG. 2, which is an embodiment of a method 200 for providing and managing currency. In block 202, a store of currency is created. In block 204, currency is received in a first denomination having a first value. In block 206, the input currency is analyzed to determine whether the currency is counterfeit. In block 208, output currency is embedded with a chemical that causes the currency to glow in certain lighting conditions. In block 210, output currency is dispensed in a second lower denomination having a second value. In block 212, usage data is generated corresponding to currency exchange operations. In block 214, the store of is replenished based on the usage data.

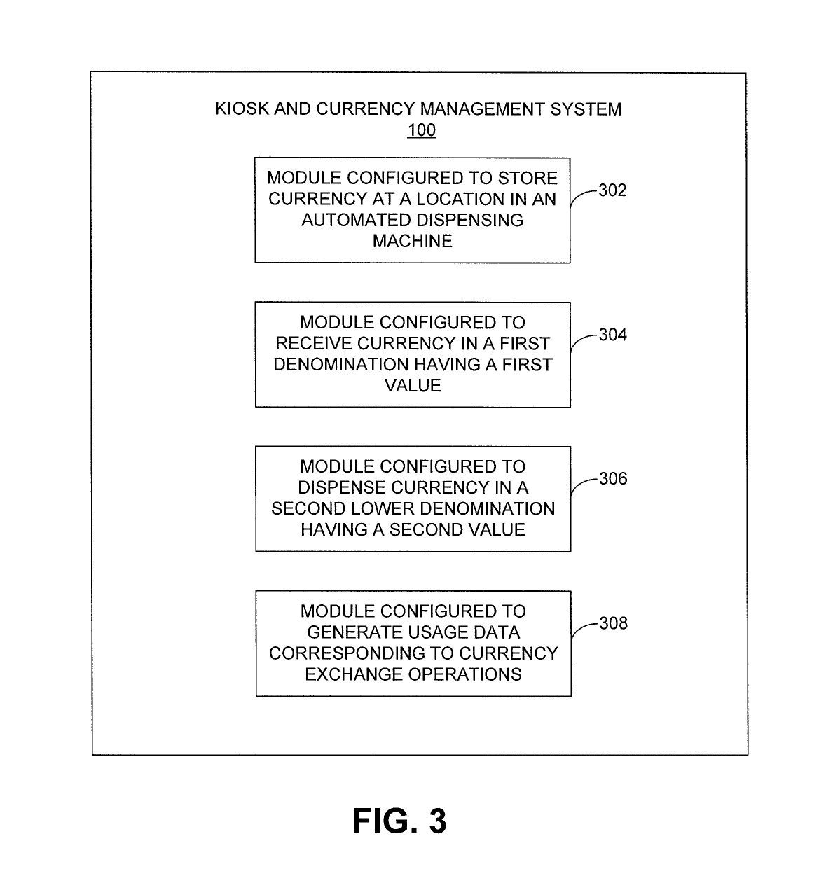

FIG. 3 is a block diagram of an embodiment of a system 300 for providing and managing currency. The system 300 includes logic 302 configured to store currency at a location in an automated dispensing machine, logic 304 configured to receive currency in a first denomination having a first value, logic 306 configured to disperse currency in a second lower denomination having a second value, and logic 308 configured to generate usage data corresponding to currency exchange operations.

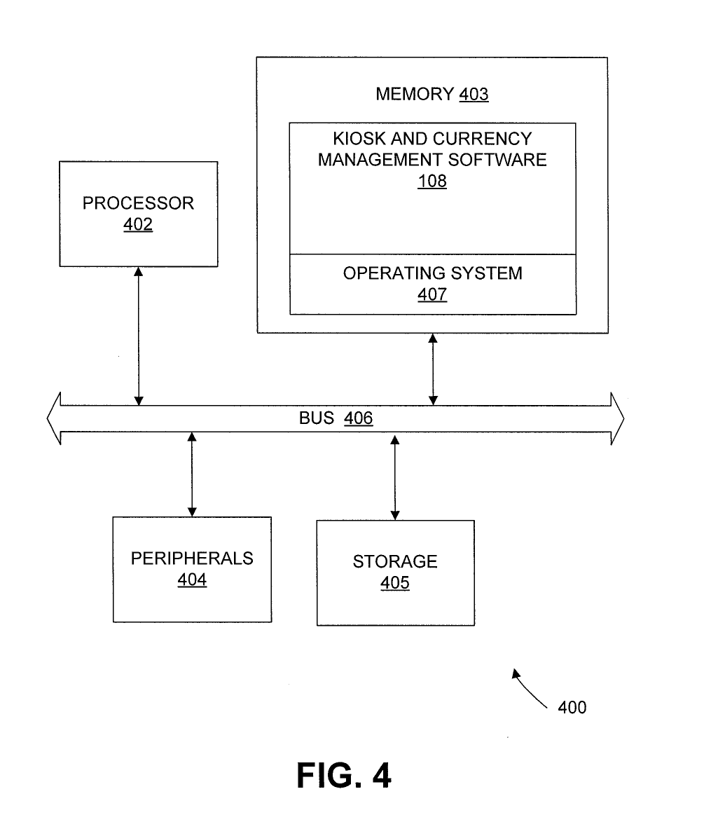

FIG. 4 is a block diagram of a computing device 400 that can be used to implement the kiosk and currency management system 100 according to various embodiments disclosed herein. The computing device contains a number of components that are familiar to a person of ordinary skill in the art, including a processor 402, memory 403, one or more peripheral devices 404, and non-volatile storage 405 (e.g., hard disk, flash RAM, flash ROM, EEPROM, etc.). The components are coupled via one or more buses 406. In an example, embodiment of computing device 300, the peripheral devices 304 include: a monitor; one or more bill acceptors such as a single note acceptor and a bunch note acceptor; a bill dispenser; a printer; a power supply; a backup power supply; a card reader; a key pad. The computing device 400 may be housed in a kiosk enclosure. Omitted from the above figure are a number of conventional components, known to those skilled in the art, which are not necessary to explain the operation of the computing device 400.

Instructions making up the kiosk and currency management software 108 are loaded into memory 403 and from there executed by the processor 402. Thus, the processor 403 is configured by these instructions to implement the kiosk and currency management software 108. Instructions making up an operating system 407 may also be loaded into memory and executed by the processor 302. While the functionality of the system 100 is described herein as being implemented by software (i.e., code executed by processor 402), in other embodiments these functions may be implemented by dedicated hardware, or by a combination of software and hardware.

In a dedicated hardware embodiment, the functionality of kiosk and currency management software 108 may instead be implemented as a circuit or state machine that employs any one of or a combination of a number of technologies. These technologies may include, but are not limited to, discrete logic, a programmable logic device, an application specific integrated circuit (ASIC), a field programmable gate array (FPGA), a system on chip (SoC), a system in package (SiP), or any other hardware device having logic gates for implementing various logic functions upon an application of one or more data signals. Such technologies are generally well known by those skilled in the art and, consequently, are not described in detail herein.

Any logic or application described herein that comprises software or code can be embodied in any non-transitory computer-readable medium for use by or in connection with an instruction execution system such as, for example, the processor 402. In this sense, the logic may comprise, for example, statements including instructions and declarations that can be fetched from the computer-readable medium and executed by the processor 402. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, having thus described various embodiments, at least the following is claimed:

1. A method for currency management comprising:
providing an automated kiosk at a business locale;
receiving, at the automated kiosk, cash currency in a first denomination having a first value from a first user;
dispensing, by the automated kiosk, cash currency in a second lower denomination having a second value; and
generating a fee to be credited to a proprietor of the business locale, wherein the fee comprises a monetary difference between the first value and the second value.

2. The method of claim 1, wherein the second denomination is a single dollar bill or bank note.

3. The method of claim 1, further comprising electronically transferring a monetary value of the fee, by the automated kiosk, to a financial account of the proprietor.

4. The method of claim 1, further comprising:
receiving, at the automated kiosk, cash currency in the second denomination having a third value from a second user; and
electronically transferring a monetary value corresponding to the received cash currency to a financial account of the second user.

5. The method of claim 1, further comprising:
receiving, at the automated kiosk, cash currency in the second denomination from a second user having a third value;
electronically transferring a monetary value corresponding to the received cash currency to a financial account of the proprietor; and
capturing an image of the second user to be associated with the electronic transfer.

6. The method of claim 1, wherein the cash currency in the first denomination is foreign currency with respect to the cash currency in the second lower denomination.

7. The method of claim 1, further comprising:
receiving, at the automated kiosk, cash currency in the second denomination from a second user having a third value;
configuring a prepaid transaction card to contain a monetary balance corresponding to the received cash currency; and
dispensing the prepaid transaction card by the automated kiosk for the second user.

8. The method of claim 1, further comprising:
receiving a prepaid transaction card from a worker at the business locale, the prepaid transaction card having a positive balance value;
electronically transferring a monetary value corresponding to a business worker fee from the positive balance value of the prepaid transaction card to a financial account of the proprietor of the business locale; and
dispensing the prepaid transaction card to the worker.

9. The method of claim 1, wherein the fee is generated when a total sum of cash currency received by the automated kiosk surpasses a predefined threshold value.

10. The method of claim 1, further comprising reporting usage data from the automated kiosk to an administrator of the automated kiosk.

11. An automated kiosk for currency management comprising:
a repository configured to store cash currency in a first denomination;
a currency receiving mechanism to receive cash currency in a first denomination having a first value from a first user;
a currency dispensing mechanism to dispense cash currency in a second denomination having a second value, wherein the second denomination is lower than the first denomination;
a processor configured to generate a fee to be credited to a proprietor of a business locale to which the automated kiosk is located, wherein the fee comprises a monetary difference between the first value and the second value; and
a communication device configured to electronically transfer the fee to a financial account of the proprietor.

12. The automated kiosk of claim 11, wherein the currency receiving mechanism is further configured to receive cash currency in the second denomination from a second user having a third value, wherein the communication device is further configured to electronically transfer a monetary value corresponding to the received cash currency to a financial account of the second user.

13. The automated kiosk of claim 11, wherein the a currency receiving mechanism is further configured to receive cash currency in the second denomination from a second user having a third value, wherein the communication device is further configured to electronically transfer a monetary value corresponding to the received cash currency to a financial account of the proprietor.

14. The automated kiosk of claim 11, wherein the communication device is further configured to send usage data collected from the automated kiosk to an administrator of the automated kiosk, the usage data comprising at least an amount of cash currency available in the repository, and frequency of use of the automated kiosk.

15. The automated kiosk of claim 11, wherein the currency receiving mechanism is further configured to receive cash currency in the second denomination from a second user having a third value, wherein the processor is further configured to implement a prepaid transaction card to contain a monetary balance corresponding to the received cash currency and cause the prepaid transaction card to be dispensed by the automated kiosk for the second user.
